(19) United States
(12) Patent Application Publication
(10) Pub. No.: US 2013/0037132 A1
(43) Pub. Date: Feb. 14, 2013

(54) Pressure-control Valve

(71) Applicant: Jeremy A. Schmoll, Pine Island, MN (US)

(72) Inventor: Jeremy A. Schmoll, Pine Island, MN (US)

(21) Appl. No.: 13/634,396

(22) PCT Filed: Apr. 20, 2011
(86) PCT No.: PCT/US11/33174

§ 371 Date: Sep. 12, 2012

Related U.S. Application Data
(60) Provisional application No. 61/328,701, filed on Apr. 28, 2010.

(51) Int. Cl. F16K 17/30; F16K 17/34

(52) U.S. Cl. 137/498; 137/505; 137/505.11; 137/517

(57) ABSTRACT

A pressure-control valve includes a housing (110) and a valve assembly (115) at least partially disposed within the housing. The housing has a sidewall (112) defining a conduit connecting an inlet opening (116) and an outlet opening (118), wherein the housing has a pressure vent (119) extending through the sidewall. The valve assembly includes: a valve seat (140), a valve support (120), a slidable member (130), and a biasing member (150). The slidable member is reversibly slidable between an open position and a closed position. The closed position interrupts fluid communication through the conduit between the inlet opening and the outlet opening. The slidable member has an upstream effective cross-sectional area greater than its downstream effective cross-sectional area. Sealing members (137,139) forming seals between the slidable member and the sidewall, and a pressure vent is disposed between the seals. A biasing member (150) biases the valve assembly (155) toward the open position.

### BACKGROUND

Water filtration systems typically include a filter medium contained within a housing. If attached to an unregulated water supply, it may be possible for pressure (e.g., from sustained or short high pressures spikes) within the housing to exceed designed operating limits, which may lead in turn to failure of the housing.

### SUMMARY

In one aspect, the present disclosure provides a pressure-control valve comprising:

a housing comprising a sidewall defining a conduit connecting an inlet opening and an outlet opening, wherein the housing has a pressure vent extending through the sidewall;

a valve assembly at least partially disposed within the housing, wherein the valve assembly comprises:
a valve seat;
a valve support;
a slidable member, wherein the slidable member is reversibly slidable between an open position and a closed position, wherein the closed position interrupts fluid communication through the conduit between the inlet opening and the outlet opening, wherein the slidable member has an upstream effective cross-sectional area and a downstream effective cross-sectional area, and wherein the upstream effective cross-sectional area is greater than the downstream effective cross-sectional area;
first and second sealing members forming respective first and second seals between the slidable member and the sidewall, wherein the pressure vent is disposed between the first and second seals; and
a biasing member, wherein the biasing member biases the valve assembly toward the open position.

In some embodiments, the valve assembly further comprises an inlet port proximate the inlet opening. In some embodiments, the pressure-control valve further comprising a third sealing member disposed between the inlet port and the valve support. In some embodiments, the inlet port comprises a first tubular insert and a first annular member, wherein the first tubular insert engages the first annular member.

In some embodiments, the valve assembly further comprises an outlet port proximate the outlet opening. In some embodiments, the outlet port comprises a second tubular insert and a fourth annular member, wherein the second tubular insert engages the second annular member.

In some embodiments, the valve assembly further comprises a valve seat support adjacent the valve seat. In some embodiments, the pressure-control valve further comprises a fourth sealing member disposed between the outlet port and the valve seat support.

In some embodiments, the biasing member comprises a coil spring. In some embodiments, the valve seat is integrally formed with the housing adjacent to the conduit. In some embodiments, the slidable member is tubular and the conduit extends longitudinally therethrough. In some embodiments, the valve assembly further comprises a valve seat support adjacent the valve seat.

Pressure-control valves according to the present disclosure are responsive to inlet pressure. Pressure-control valves according to the present disclosure are useful, for example, to regulate fluid pressure within a specified pressure range, thereby eliminating pressure overages that may cause harm to downstream fluid handling components such as, for example, cartridge filters. Advantageously, at least some pressure-control valves according to the present disclosure can be manufactured as simple compact devices.

As used herein:

the term “downstream” means positioned relatively closer to the outlet opening than the inlet opening; and

the term “upstream” means positioned relatively closer to the inlet opening than the outlet opening.

The foregoing embodiments may be implemented in any combination thereof, unless such combination is clearly erroneous in view of the teachings of the present disclosure. The features and advantages of the present disclosure will be further understood upon consideration of the detailed description as well as the appended claims.

### BRIEF DESCRIPTION OF THE DRAWINGS

FIG. 1 is an exploded perspective view of an exemplary pressure-control valve 100 according to one embodiment of the present disclosure;

FIG. 2 is a plan view from the upstream end of pressure-control valve 100, shown in FIG. 1;

FIG. 3A is a cross-sectional view of the pressure-control valve 100 taken along line A-A of FIG. 2, and shown with the slidable member 130 in an open position;

FIG. 3B is a cross-sectional view of the pressure-control valve 100 taken along line A-A of FIG. 2, and shown with the slidable member 130 in an closed position;

FIG. 4 is a cross-sectional view of inlet port 170 taken along line A-A of FIG. 2;

FIG. 5 is a cross-sectional view of valve support 120 taken along line A-A of FIG. 2;

FIG. 6 is a cross-sectional view of slidable member 130 taken along line A-A of FIG. 2;

FIG. 7A is a cross-sectional view of housing 110 taken along line A-A of FIG. 2;

FIG. 7B is a top view of housing 110 shown in FIG. 7A; and

FIG. 7C is a bottom view of housing 110 shown in FIG. 7A.

While the above-identified drawing figures set forth several embodiments of the present disclosure, other embodiments are also contemplated; for example, as indicated in the discussion. In all cases, this disclosure presents the disclosure by way of representation and not limitation. It should be understood that numerous other modifications and embodiments can be devised by those skilled in the art, which fall within the scope and spirit of the principles of the present disclosure. The figures may not be drawn to scale. Like reference numbers may have been used throughout the figures to denote like parts.

### DETAILED DESCRIPTION

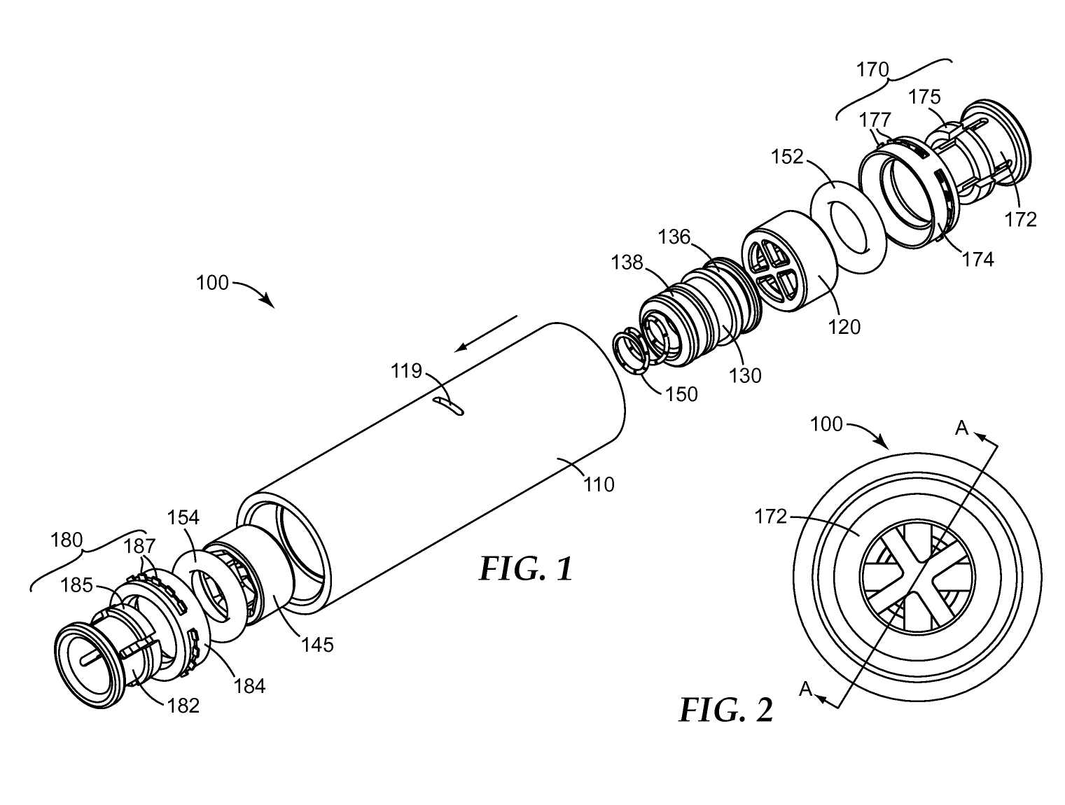

FIG. 1 depicts exemplary pressure-control valve 100 in exploded perspective view for general reference. Greater detail will be apparent in view of the remaining figures and the following discussion.

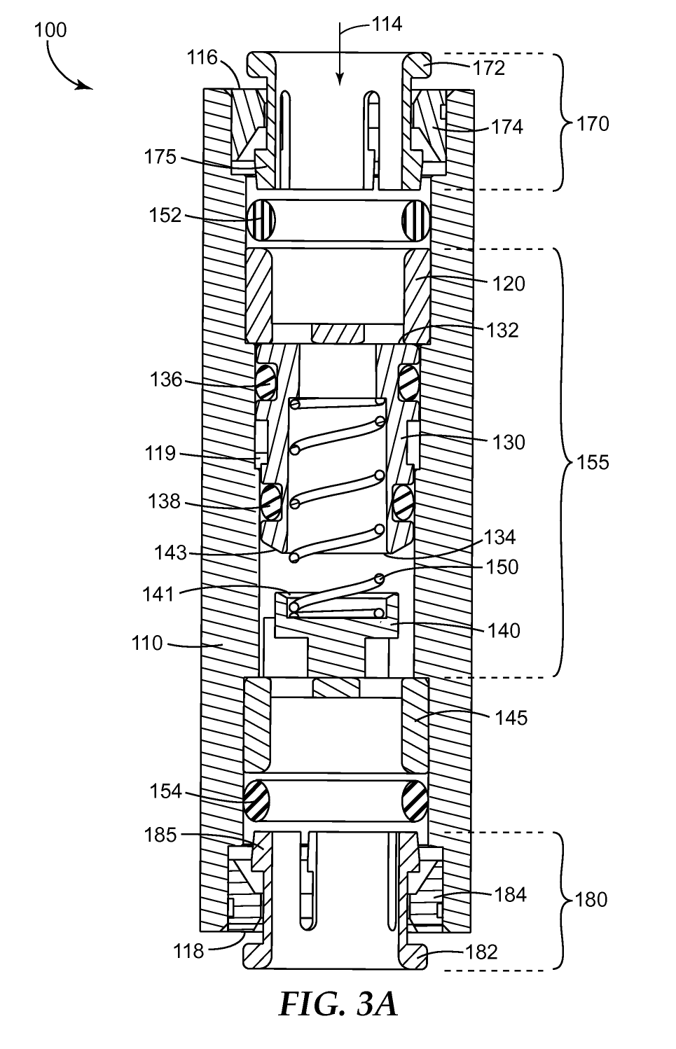

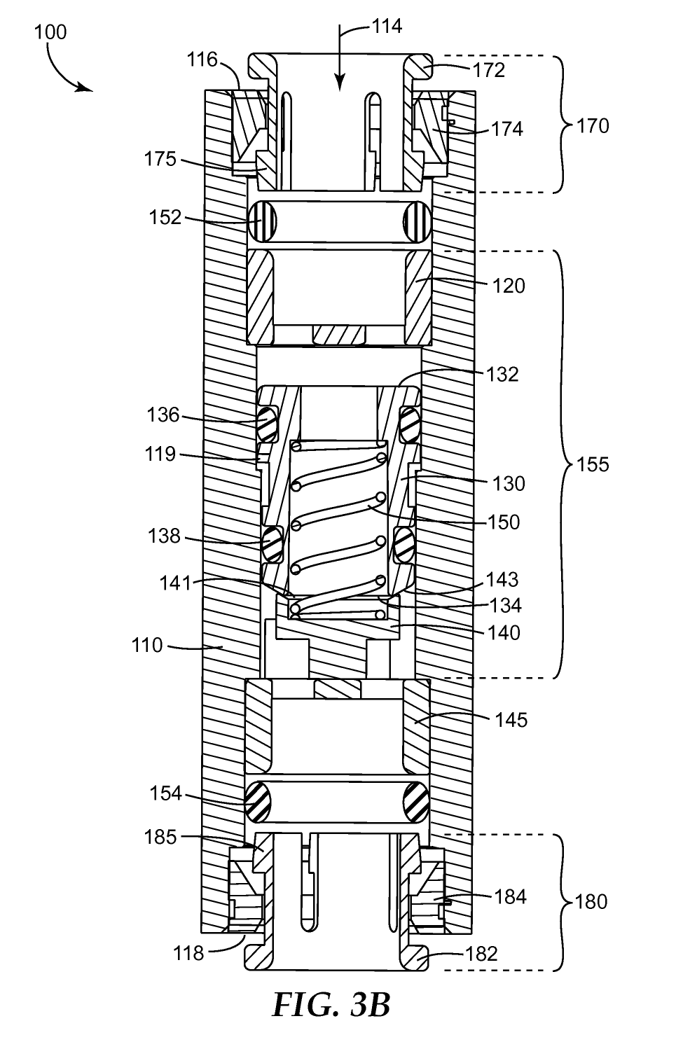

Referring now to FIGS. 3A and 3B, valve assembly 155 is disposed within housing 110. Valve assembly 155 comprises valve seat 140, valve support 120, slidable member 130, and biasing member 150.

Slidable member 130 is reversibly slidable between an open position (shown in FIG. 3A) and a closed position (shown in FIG. 3B). In the closed position, valve seat 140 engages slidable member 130 to form a seal that interrupts fluid communication through the conduit between the inlet opening and the outlet opening. First and second sealing members (136, 138) form respective first and second seals (137, 139) between slidable member 130 and sidewall 112. Pressure vent 119 is disposed between first and second seals (137, 139). Slidable member 130 has an upstream effective cross-sectional area 132 and a downstream effective cross-sectional area 134. Upstream effective cross-sectional area 132 is greater than downstream effective cross-sectional area 134. Since the upstream effective cross-sectional area is greater than the downstream effective cross-sectional area there is a net fluid force, opposite the force applied by the biasing member, which urges the valve assembly toward the closed position.

Pressure vent 119 serves to equalize pressure during sliding of the slidable member. Absent the pressure vent, the volume of the space defined by the first and second seals, the slidable member, and the sidewall would increase in that portion of the conduit in contact with the larger. Accordingly, the pressure would rise and/or fall as the slidable member is moved between the open and closed positions, which could lead to problems in proper valve assembly operation.

Valve seat 140 (see FIGS. 3A and 3B) is optionally integrally formed with housing 110. As shown, valve seat 140 has a chamfered opening 141 that engages a tapered tip 143 of slidable member to form a fluid-tight seal; however, it is envisioned that other configurations capable of forming a fluid-tight seal may also be used.

Biasing member 150 may be any device that will permit passage of fluid and urge the slidable member toward the closed position. Typical examples include springs (e.g., coil springs).

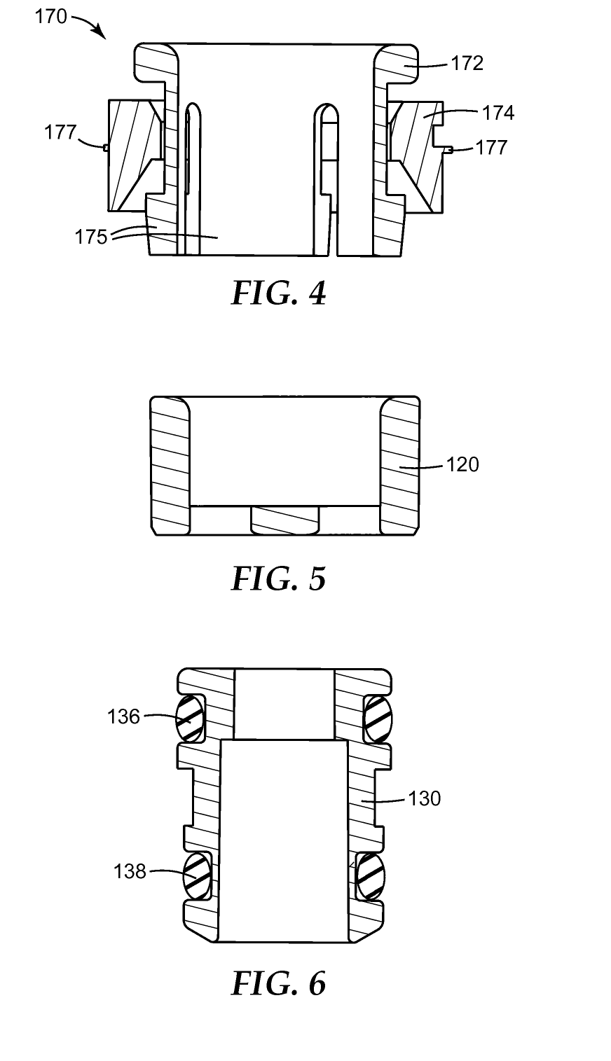

Referring now to FIGS. 1 and 4, optional inlet port 170 is disposed proximate to the inlet opening 116. As shown, optional inlet port 170 has a first tubular insert 172 that engages first annular member 174. First spring clips 175 on first tubular insert 172 retain the first tubular insert 172 within the opening of first annular member 174. Similarly, first spring tabs 177 engage housing 110 and serve to retain optional inlet port 170 within inlet opening 116.

Optional outlet port 180 is disposed proximate to outlet opening 118. As shown, optional outlet port 180 has a second tubular insert 182 that engages second annular member 184. Second spring clips 185 on second tubular insert 182 retain the second tubular insert 182 within the opening of second annular member 184. Similarly, second spring tabs 187 engage housing 110 and serve to retain optional outlet port 180 within outlet opening 118.

While shown in interchangeable forms, the inlet port and the outlet port may have different shapes and/or sizes. Of course, manufacturing simplicity may favor interchangeable configurations. Similarly, the optional inlet and outlet ports may comprise single bodies or combinations of several component parts.

Referring now to FIGS. 1, 3A, and 5, valve support 120 which serves to support the biasing member 150, and limit travel of the slidable member, is disposed within housing 110. As shown, valve support 120 is substantially tubular with an open lattice structure on its downstream end. In some embodiments, the valve support is integrally formed with housing 110.

Referring now to FIGS. 1, 3A, and 5, optional valve seat support 145, which serves to support the valve seat 140, and help retain the optional fourth sealing member 154, is disposed adjacent to valve seat 140. As shown, optional valve seat support 145 has the same shape and size as valve support 120, although this need not be the case. In some embodiments, the valve seat is integrally included in valve seat support, while in the embodiment shown as pressure-control valve 100 the valve seat 140 is integrally formed with housing 110.

Referring again to FIG. 1, optional third and fourth sealing members (152, 154) serve to prevent leakage if either or both of optional inlet port 170 and optional outlet port 180 are present. If present, optional third sealing member 152 is disposed between optional inlet port 170 and valve support 120. Similarly, if present, optional fourth sealing member 154 is disposed between optional outlet port 180 and optional valve seat support 145 (or valve seat 140).

The first second, third, and fourth sealing members may comprise any suitable material and be of any suitable shape and/or size that will effectively form the intended seal. In general the seals should remain fluid tight over the intended operating fluid pressure of the pressure-control valve. Examples of suitable sealing members include elastomeric o-rings, gaskets, and pressure packing. Typically, a grease (e.g., a silicone grease or a petroleum-based grease) or other lubricant may be used in conjunction with the sealing member to facilitate movement and sealing.

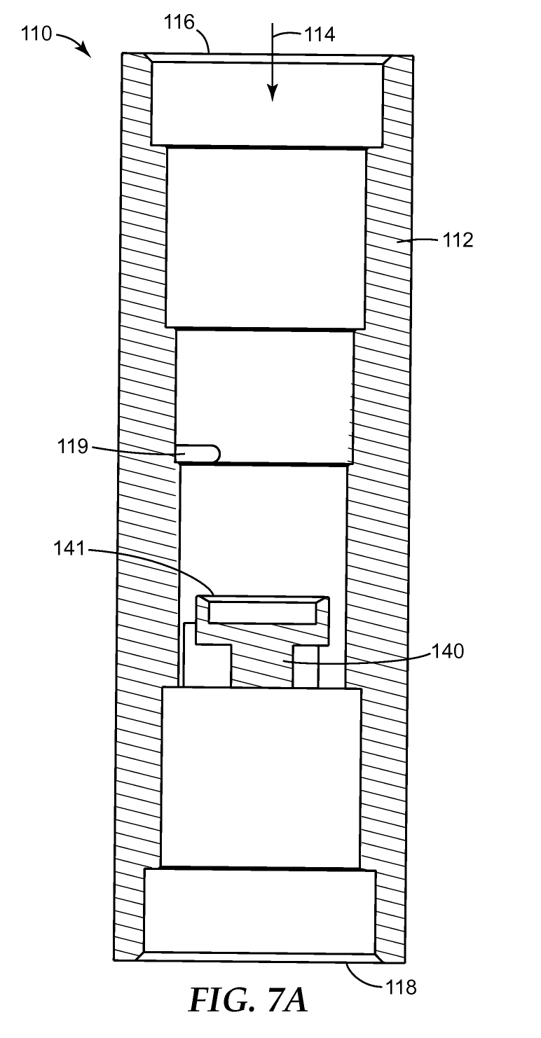

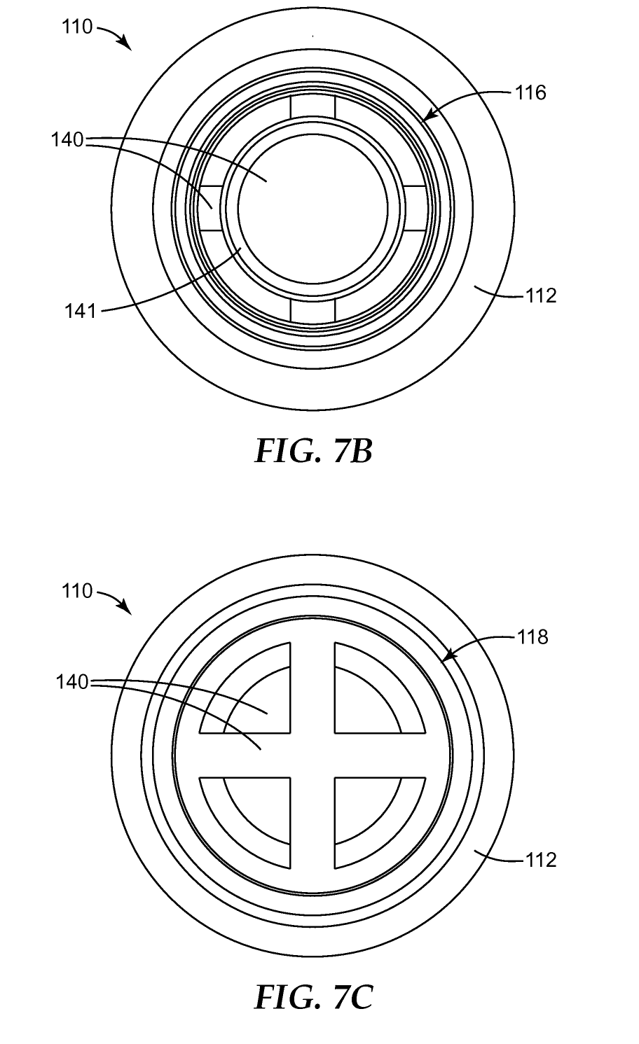

Referring now to FIGS. 1 and 7A-7C, slidable member 130 is tubular and the conduit extends longitudinally therethrough. However, it is envisioned that other configurations that capture the essential principle of operation may also be used. For example, fluid may flow through the slidable member through multiple conduits and/or channels. The slidable member is generally cylindrical, except that different regions have different diameters. For example, the diameter of the slidable member is smaller toward its downstream end than toward its upstream end. Accordingly, the diameter of the generally cylindrical conduit within the housing is correspondingly larger at its upstream end than at its downstream end. First and second sealing members (136, 138), shown as elastomeric o-rings, are circumferentially disposed around the slidable member and disposed within the conduit such that pressure vent 119 is disposed within the seals formed by the first and second sealing members.

Notably, the slidable member has a greater upstream effective cross-sectional than its downstream effective cross-sectional area, resulting in a pressure gradient across the length of the slidable member that opposes the force applied by the biasing member. Hence, if a pressure spike should occur in the inlet fluid pressure, the slidable member is urged toward the closed position of the valve assembly. As the spike in pressure subsides, the slidable member is urged away from the valve seat by the biasing member and fluid flow through the pressure-control valve resumes.

Referring now to FIGS. 7A-7C, housing 110 has sidewall 112 defining conduit 114. Conduit 114 extends from inlet opening 116 to outlet opening 118. Valve seat 140 is integrally formed with housing 110. As discussed hereinabove, pressure vent 119 serves to equalize pressure due to free volume changes during sliding of the slidable member 130. As shown, conduit 114 has a substantially cylindrical shape, with periodic changes in cylinder diameter occurring along its length. These periodic diameter changes are useful, for example, for positioning components during assembly of the pressure-control valve, and for proper functioning of the slidable member. In addition, variations in diameter of the conduit may be used to adjust fluid pressure. Other configurations of the conduit may also be used, as long as the slidable member is capable of sliding between the open and closed valve assembly positions.

The various components of the pressure-control valve may be fabricated of any suitable material such as, for example, plastic, metal, and rubber. Engineering thermoplastics that are approved for food contact are typically desirable. Examples include nylon, polyethylene, polypropylene, polyimide, polyethersulfone, polyether ether ketone (PEEK), polyphenylene oxide, polytetrafluoroethylene, and acetal copolymer.

Pressure-control valves according to the present disclosure are suitable for use with fluids such as, for example, potable water, coolant fluid, waste water, and fermentation broth.

Various modifications and alterations of this disclosure may be made by those skilled in the art without departing from the scope and spirit of this disclosure, and it should be understood that this disclosure is not to be unduly limited to the illustrative embodiments set forth herein.

1. A pressure-control valve comprising:
a housing comprising a sidewall defining a conduit connecting an inlet opening and an outlet opening, wherein the housing has a pressure vent extending through the sidewall;
a valve assembly at least partially disposed within the housing, wherein the valve assembly comprises:
a valve seat, wherein the valve seat is integrally formed with the housing adjacent to the conduit;
a valve support;
a slidable member, wherein the slidable member is reversibly slidable between an open position and a closed position, wherein the closed position interrupts fluid communication through the conduit between the inlet opening and the outlet opening, wherein the slidable member has an upstream effective cross-sectional area and a downstream effective cross-sectional area, wherein the upstream effective cross-sectional area is greater than the downstream effective cross-sectional area, and wherein the slidable member is tubular and the conduit extends longitudinally therethrough;
first and second sealing members forming respective first and second seals between the slidable member and the sidewall, wherein the pressure vent is disposed between the first and second seals; and
a biasing member, wherein the biasing member biases the valve assembly toward the open position.

2. The pressure-control valve of claim 1, wherein the valve assembly further comprises an inlet port proximate the inlet opening.

3. The pressure-control valve of claim 2, further comprising a third sealing member disposed between the inlet port and the valve support.

4. The pressure-control valve of claim 2, wherein the inlet port comprises a first tubular insert and a first annular member, wherein the first tubular insert engages the first annular member.

5. The pressure-control valve of claim 1, wherein the valve assembly further comprises an outlet port proximate the outlet opening.

6. The pressure-control valve of claim 5, wherein the outlet port comprises a second tubular insert and a second annular member, wherein the second tubular insert engages the second annular member.

7. The pressure-control valve of claim 5, wherein the valve assembly further comprises a valve seat support adjacent the valve seat.

8. The pressure-control valve of claim 7, further comprising a fourth sealing member disposed between the outlet port and the valve seat support.

9. The pressure-control valve of claim 1, wherein the biasing member comprises a coil spring.

10. (canceled)

11. (canceled)

12. The pressure-control valve of claim 1, wherein the valve assembly further comprises a valve seat support adjacent the valve seat.

13. The pressure-control valve of claim 1, wherein the valve assembly further comprises a valve seat support adjacent the valve seat.
